(19) United States
(12) Patent Application Publication
(10) Pub. No.: US 2026/0076493 A1
(43) Pub. Date: Mar. 19, 2026

(54) Method and system for singulating and dispensing an object, fruit or produce

(71) Applicant: Vebu Inc., Gardena, CA (US)

(72) Inventors: Blake Edward Winner, South Pasadena, CA (US); Arthur Francois David Levy, Los Angeles, CA (US); Aaron Lucas, Sherman Oaks, CA (US); Praveen Kumar Nooli, Frisco, TX (US)

(21) Appl. No.: 19/325,314

(22) Filed: Sep. 10, 2025

Related U.S. Application Data
(60) Provisional application No. 63/694,723, filed on Sep. 13, 2024.
(60) Provisional application No. 63/694,716, filed on Sep. 13, 2024.
(60) Provisional application No. 63/694,293, filed on Sep. 13, 2024.

(51) Int. Cl. A47F 1/12; B65G 47/14

(52) U.S. Cl. CPC A47F 1/125; B65G 47/1421; B65G 2201/0211; B65G 2203/044

(57) ABSTRACT

An automated system for singulating and dispensing an object from a bunch of objects comprises: a hopper adapted to hold the bunch of objects; a rotating drum arranged adjacent the hopper and comprising at least one cutout to pick up one object at a time from the bunch of objects in the hopper; a funnel arranged on an opposing side of the drum to the hopper, wherein the drum is operable to transfer one of the objects at a time from the hopper to the funnel; and a trapdoor assembly at the base of the funnel comprising a first closed configuration for staging the object, and a second open configuration for transferring the object to a processing area for further processing. Computer and electronics are programmed and operable to control the modules. Related methods are described.

### CROSS-REFERENCE TO RELATED APPLICATIONS

This application claims priority to provisional application no. 63/694,723, filed September 13, 2024, entitled “AUTOMATED PRODUCE DE-SEEDING AND PULP EXTRACTION MACHINE”; provisional application no. 63/694,716, filed September 13, 2024, entitled “Method for Automated Extraction of pulp, juice and other products from an encapsulated fruit, produce, or seed”; and provisional application no. 63/694,293, filed September 13, 2024, entitled “Method and system for singulating and dispensing an object, fruit or produce”, each of which is incorporated by reference in its entirety for all purposes.

### BACKGROUND OF THE INVENTION

### 1. Field of the Invention

This invention relates to food processing systems, and more particularly, to automated food processing systems adapted to singulate and dispense an item such as a fruit or produce.

### 2. Description of Related Art

In commercial applications, there is a need for a method to process multiple types of fruit or produce in a single, compact, high throughput, inherently food safe and easily cleanable system. Some partial solutions to this problem exist such as kitchen juicers, industrial pulp extractors, tools to aid in manual fruit or produce processing but all of them only address one part of the problem. Industrial solutions cannot fit within commercial kitchens and tend to rely on further processing to create a food safe product. Relevant kitchen equipment, both manual and automated is usually geared towards processing of a single type of fruit or produce in very low quantity and are not adapted for the high throughput demands of a commercial kitchen.

Additionally, in small batch processing where space is limited and the object is variable in weight and size, the object is prone to jamming or doesn’t slide or roll easily. Some vibratory systems can address this challenge however, they are usually very large for use in bulk material processing and often require large amounts of power and careful tuning to the material weight.

Some systems employ conveyor belts to transfer product. However, belt assemblies are complicated, expensive, and difficult to clean. Additionally, belt systems are less adapted to conveying items from a heap, thus requiring more surface area to space apart items.

There is therefore a need for an improved method and system for singulating and dispensing an item such as a fruit or produce, and particularly, one that is automated, compact, easily cleanable, and can quickly process multiple objects in the restaurant environment.

### SUMMARY OF THE INVENTION

Described herein is a method and system for singulating and dispensing an item, fruit or produce from a bunch or heap of the objects.

In embodiments of the invention, a system for singulating and dispensing an item, fruit or produce includes a hopper, rotating drum, funnel, and trapdoor.

In embodiments of the invention, the hopper is adapted to hold the bunch of objects. The rotating drum is arranged at the output of the hopper and comprises at least one cutout to pick up one object at a time from the bunch of objects in the hopper. The funnel is arranged on an opposing side of the drum to the hopper, wherein the drum is operable to transfer one of the objects at a time from the hopper to the funnel. The trapdoor is arranged at the base of the funnel and comprises a first closed configuration for staging the object, and a second open configuration for transferring the object to a processing area for further processing.

In embodiments of the invention, a vibration assembly is arranged with the hopper to convey the item towards the drum.

In embodiments of the invention, a curtain is arranged above the interface between the hopper exit and the drum to prevent item from passing over the top of the drum.

In embodiments of the invention, a controller is operable to stop the drum from rotating and the hopper from vibrating based on data from a sensor wherein the sensor monitors for an item entering the funnel.

In embodiments of the invention, the funnel directs the item onto the trapdoors.

In embodiments of the invention, the trapdoors include elongated fingers that, when closed, interlace to collectively form a slightly bowl-shaped or concave surface for the item to roll or slide into the lowest point of the formed depression.

In embodiments of the invention, the singulated item is dispensed through the trapdoors.

In embodiments of the invention, the trapdoors operate together to stage and center the item as it is dropped from the trapdoors.

In embodiments of the invention, the trapdoors are opened at a varying speed.

In embodiments of the invention, the trapdoors’ motion follows a profile wherein they first open slowly to allow the item to roll or slide into the bowl-shaped depression formed by the trapdoors’ fingers then open rapidly to drop the item. The slow part of the motion serves to center the item into the depression, the low speeding allowing time for the item to get into position. The rapid part of the motion ensures the item is dropped without further rolling, resulting in a near vertical drop and limiting the rotation and sideways motion that could be imparted to the item by interaction of its varied and irregular shape with the trapdoors during the drop.

In embodiments of the invention, the trapdoors’ motion may follow a constant speed if the item being processed has a low propensity to gather rotational or sideways motion during the drop.

In embodiments of the invention, prior to moving down and opening to drop the item, the trapdoors may individually move up slightly then back down the same amount one or more times, optionally one at a time in an attempt to roll the item into a more centered position and an orientation where the major axis of the item is parallel with the intersection axis of both trapdoors.

In embodiments of the invention, one trapdoor may open first fully before the other opens slowly in an effort to control the descent of the item by letting gravity urge it against the first trapdoor.

In embodiments of the invention, the trapdoors may open symmetrically or asymmetrically in multiple sequenced steps. For example, each trapdoor opens by a small amount one after the other repeatedly until the full opening is reached by both trapdoors. Further, the trapdoors may partially reverse during these opening motions. These different motion profiles are meant to jostle and roll the fruit within the trapdoors to help move it to a desired orientation.

In embodiments of the invention, a trapdoor assembly includes only one trapdoor.

In embodiments of the invention, the system is both produce type and size agnostic based on one or more of the following: a vibration hopper sized to fit one full case of avocados; a drum pocket geometry designed to fit a single large-sized fruit (size 32) and also disallow more than a single small-sized fruit (size 84); and trapdoor lengths sized to accept any size fruit.

In embodiments of the invention, the item is an avocado, and the components are sized accordingly.

In embodiments of the invention, a system is programmed and operable to collect data from sensors or otherwise (e.g., time elapsed, count, proximity, load cell data) to create metrics for yield, throughput, etc. In embodiments, the metrics are available or sent to end user QSRs to evaluate savings, efficiencies, average consumption, etc.

In embodiments of the invention, the system further comprises a dashboard comprising a plurality of user input features (e.g., levers, knobs, buttons, touch screen, etc.) and indicators (LEDS, display) to control actions (e.g., power, start stop, component speed, dispense, etc.) and show the status (e.g., on/off, error status) of the system that may prompt the user/operator to interact with the system.

### OBJECTS AND ADVANTAGES

Objects and advantages of various embodiments of the invention include one or more of the following:

A hopper and singulation produce processing mechanism or assembly having a loading capacity of up to a full 25lbs case of avocados or other types of fruit or produce.

A hopper and singulation produce processing mechanism or assembly operable to process different or variations in size and shape of the produce that are typically inherent to fruits/vegetables.

A hopper and singulation produce processing mechanism or assembly operable to consistently convey an irregularly shaped object even when the objects are stacked in a pile.

A hopper and singulation produce processing mechanism or assembly impervious to issues such as bridging and clogging.

A hopper and singulation produce processing mechanism or assembly that doesn’t necessitate spreading the produce to convey over a large area to prevent stacking.

A hopper and singulation produce processing mechanism or assembly that is easy to clean.

A hopper and singulation produce processing mechanism or assembly comprising a food safe seal, and optionally, wherein the seal is between a vibrating plate and the hopper to shield the actuation system from food byproducts. Alternatively, the seal may be replaced by an overhanging barrier to prevent the spillage of liquids into the actuation system.

The description, objects and advantages of the present invention will become apparent from the detailed description to follow, together with the accompanying drawings.

### BRIEF DESCRIPTION OF THE DRAWINGS

FIG. 1 is a right-side isometric view of an automated avocado processing system shown in an open configuration in accordance with an embodiment of the invention;

FIG. 2 is a top view of the automated avocado processing system shown in FIG. 1;

FIG. 3 is a front view of the automated avocado processing system shown in FIG. 1;

FIG. 4 is a right side view of the automated avocado processing system shown in FIG. 1;

FIG. 5 is an upper right side perspective view of a hopper and singulation assembly in accordance with an embodiment of the invention;

FIG. 6 is a top view of the hopper and singulation assembly shown in FIG. 5;

FIG. 7 is a right side view of the hopper and singulation assembly shown in FIG. 5;

FIG. 8 is a bottom view of the hopper and singulation assembly shown in FIG. 5 with the trapdoor shown in an open configuration;

FIG. 9 is a rear bottom view of the hopper and singulation assembly shown in FIG. 5 with the trapdoor shown in an open configuration;

FIG. 10 is a lower left side perspective view of a hopper assembly in accordance with an embodiment of the invention;

FIG. 11 is a sectional view of the hopper assembly shown in FIG. 10 with the bin removed;

FIG. 12 is a flow chart of a method for singulating a item in accordance with an embodiment of the invention;

FIGS. 13-15 sequentially illustrate singulating an avocado in accordance with an embodiment of the invention;

FIG. 16 is a block diagram of an automated avocado processing system in accordance with an embodiment of the invention;

FIG. 17 is a schematic diagram of a hopper module in accordance with an embodiment of the invention; and

FIG. 18 is a software architecture diagram of an avocado processing system in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### APPARATUS OVERVIEW

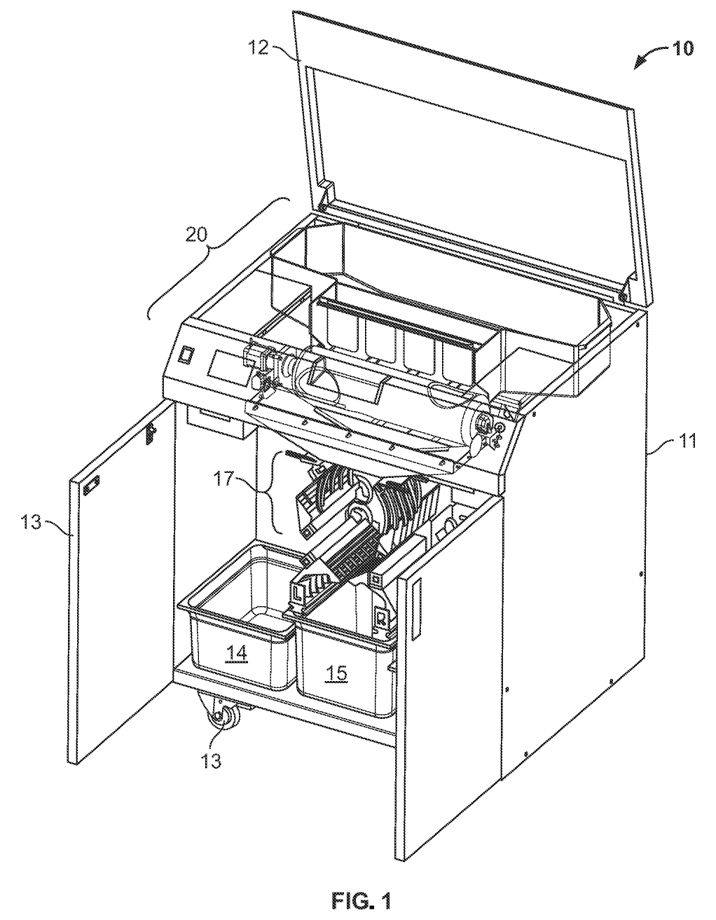

FIG. 1 shows an automated avocado processing system 10 in accordance with an embodiment of the invention. The system 10 has an enclosure or frame 11 including a pivotable lid 12 shown in the open configuration. When the lid 12 is closed, the lid can serve as a work surface. Castor wheels 13 are arranged on the feet of the frame to conveniently roll the entire system.

The enclosure 11 houses a loading and singulation station 20, a processing station 17 (optionally for cutting, coring or peeling), food and waste pans 14, 15 respectively, and computer and electronics (not shown), each of which is discussed further herein.

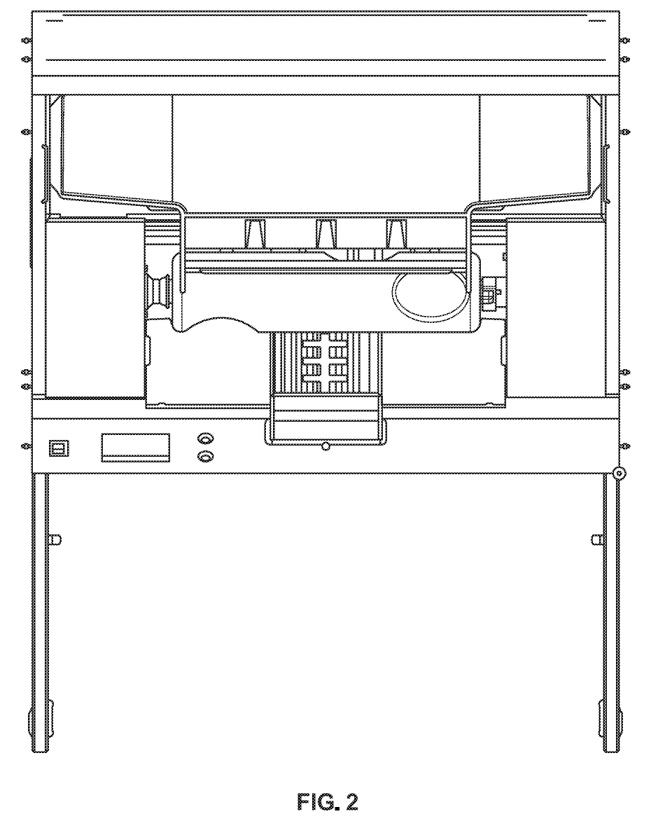

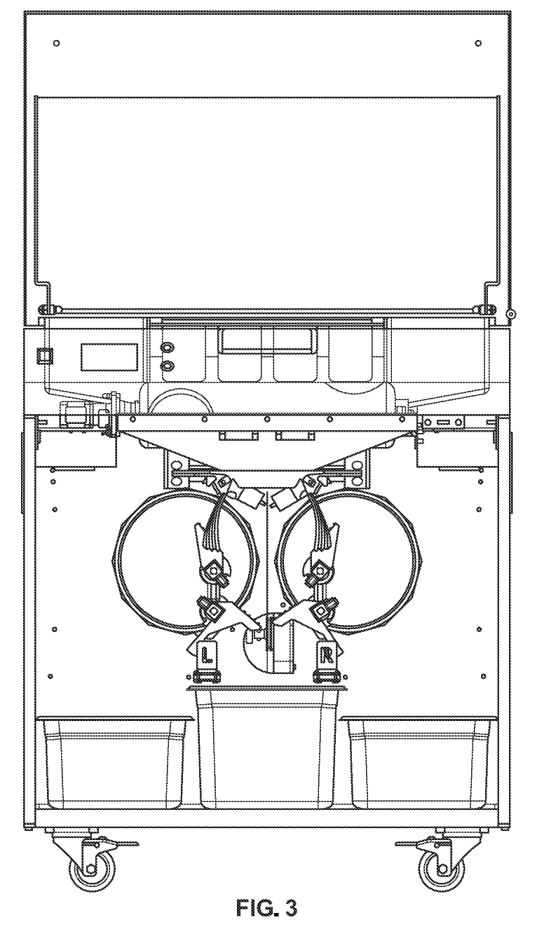

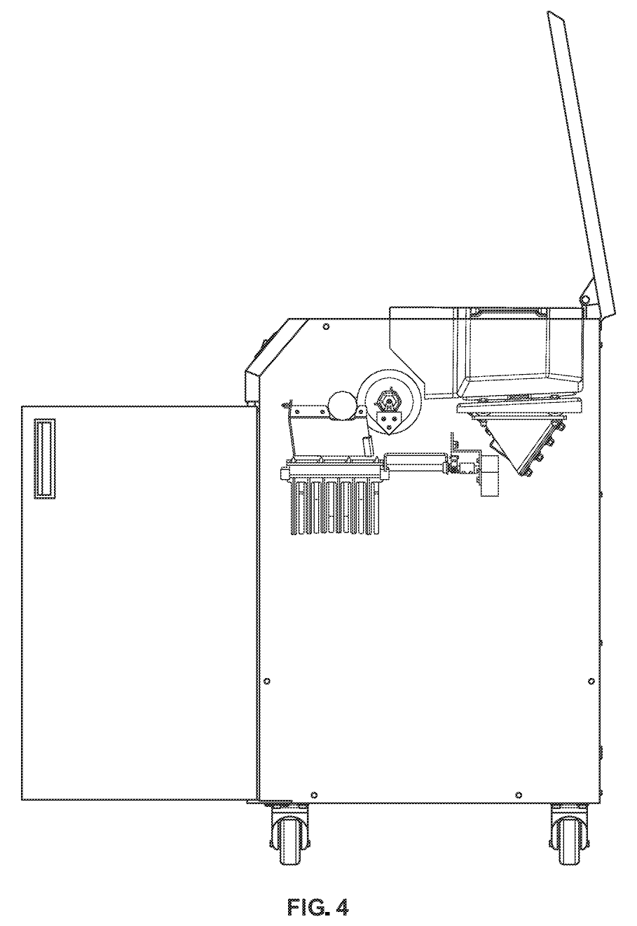

FIGS. 2-4 show additional views of the automated avocado processing system 10, illustrating the relative internal arrangement of the components to one another within the enclosure 11.

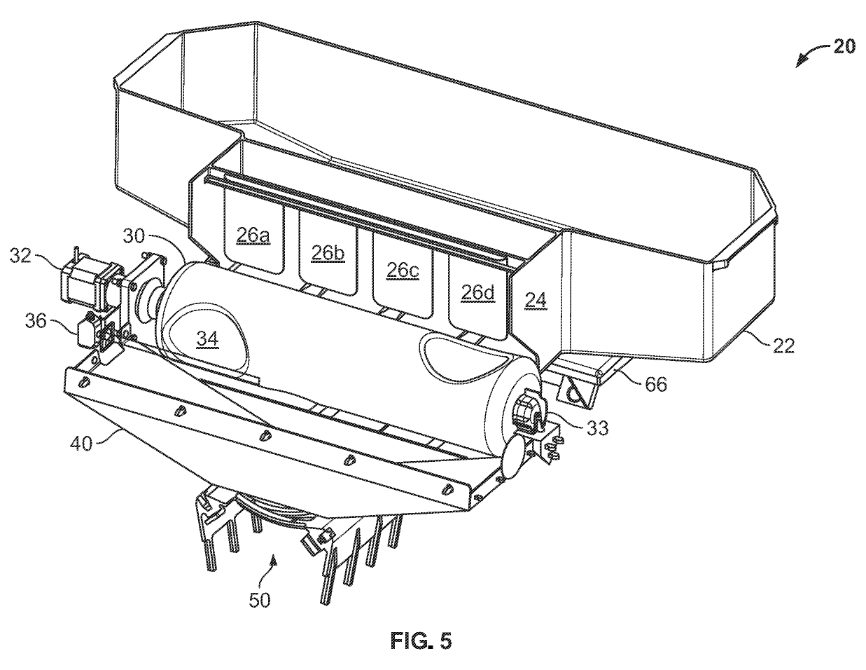

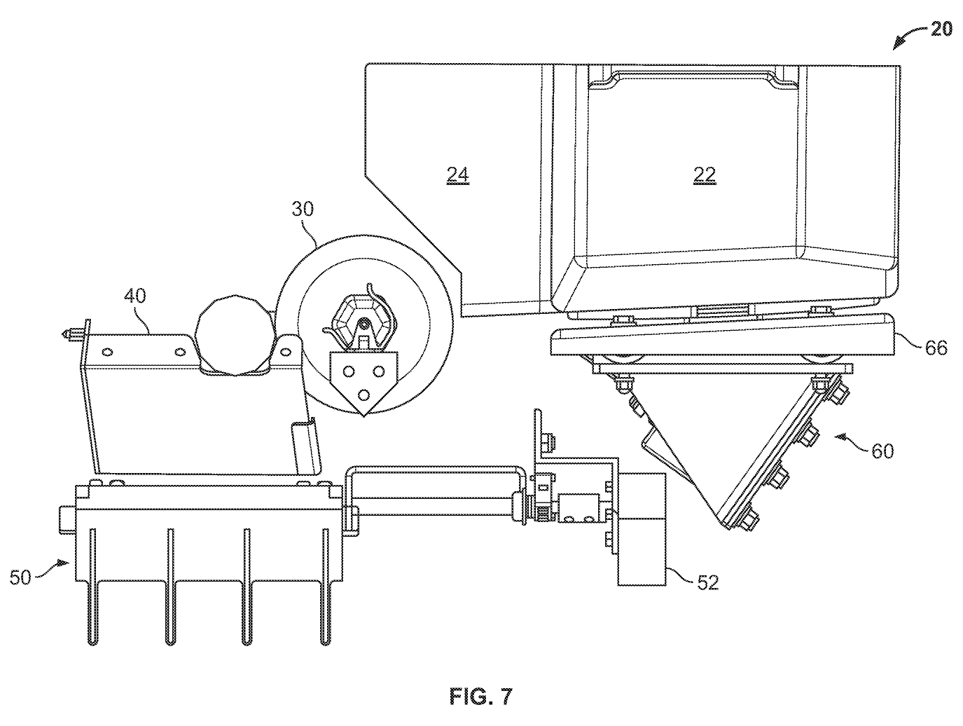

FIGS. 5-8 are enlarged isolated views of a hopper and singulation assembly 20 in accordance with embodiments of the invention.

The assembly 20 is shown having a hopper bin 22, rotating drum 30, funnel 40, trapdoor 50.

The hopper assembly 20 includes a multi-chamber item holding area comprised of a first chamber 22 and a smaller second downstream chamber 24. Both the first and second chambers are shown having a slight downward angle. The downward angle is preferably less than 10 degrees and in some embodiments is under 5 degrees. Second chamber 24 is also shown having several ridges 26 (or ramp features) serving to organize the item into channels that are aligned with pockets 34 in the drum 30, serving to reduce the time needed for the drum to pick up items.

Optionally, as discussed further herein, the hopper bin 22 can be operable to vibrate. Vibrations convey the item towards the second chamber and drum. Preferably, the vibration is controlled to only feed item as fast as the system needs based on sensor data, discussed herein.

In embodiments, the hopper bin has magnets fastened to its underside, to facilitate locating and attaching the hopper bin to base vibration plate 66. The vibration plate 66 can be made of a magnetic-sensitive material like SS 400 series or Iron, or have magnets attached to the plate. The hopper underside can have a self-locating feature in its underside to help quick assembly and disassembly (e.g., a tab or protruding shape).

The motorized drum 30 includes a plurality of pockets 34 that pick up one item at a time from the second hopper chamber 24. The drum 30 is shown with four (4) pockets spaced apart equally along its length, and along its circumference (e.g., each pocket is 90 degrees from an adjacent pocket). The amount, spacing and phase angle of the pockets may be changed and adapted to better suit a produce type, a downstream processing system, or a manufacturing method. Additionally, the pockets 34 are specifically sized and shaped such that each pocket can accommodate a large variance in item size but only pick up one item at a time. An exemplary shape of the pocket is a semi-ovoid or semi-ellipsoid. Exemplary dimensions for the length (major axis) 90mm to 110mm, width (the widest part of the pocket) 60mm to 80mm, and the height (the vertical dimension perpendicular to the length and width) 30mm to 50mm.

The drum 30 is removable from the hopper assembly for cleaning. In the embodiment shown in FIG. 5, the drum 30 fits into a hexagon-shaped drive coupling on the motor side 32 and into a clip 33 on the second side such that the drum can be easily removed for cleaning.

Optionally, a divider such as a flexible plastic curtain can be arranged above an interface between the drum 30 and the hopper bin 24 to prevent items from passing over the top of the drum. The curtain can be detachably attached to the top of the second chamber 24 of the hopper bin such that it can be easily removed for cleaning. With reference to FIG. 5, a curtain is shown composed of separate flaps (26a, 26b, 26c, 26d) aligned over each drum pocket 34.

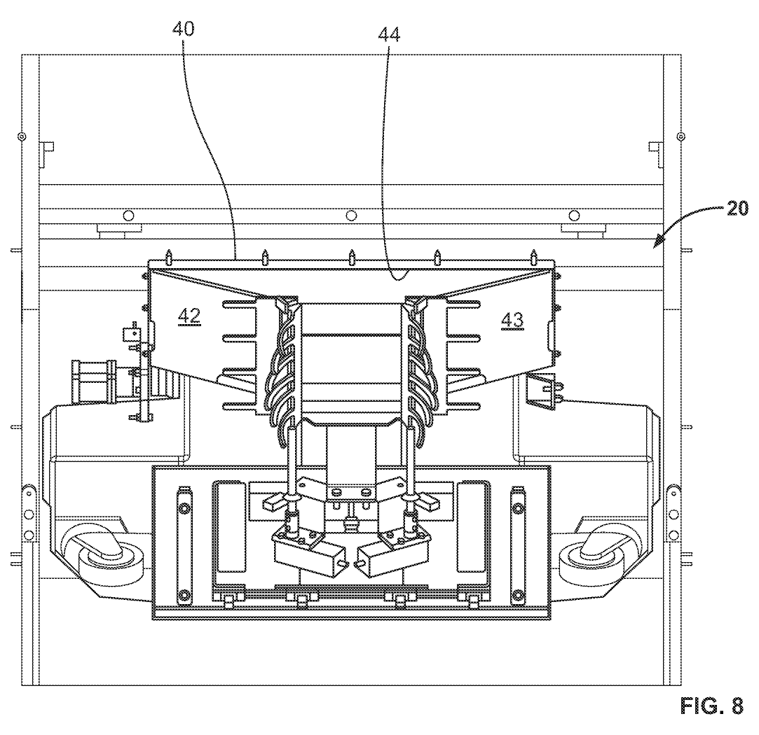

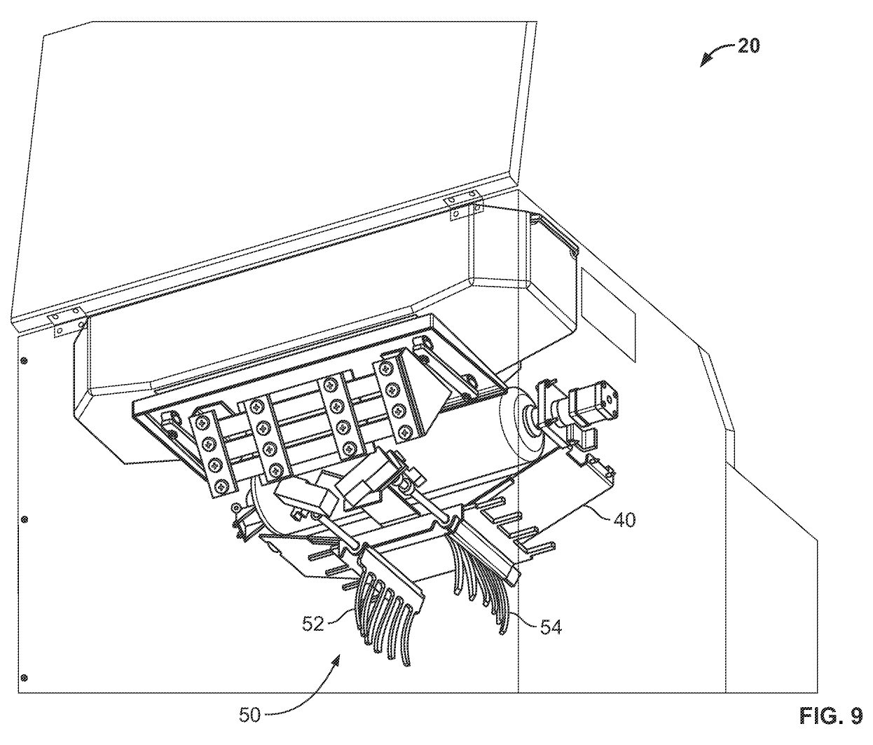

With reference to FIGS. 8-9, the hopper assembly 20 also includes a funnel 40 which directs the item transferred from the drum 30 onto a trapdoor assembly 50. The funnel 40 is shown having a width equal to that of the drum 30, opposing symmetric side ramps 42, 43, and a square-shaped egress 44 to which the side ramps direct the item.

With reference to FIG. 9, the trapdoor assembly 50 includes a pair of motorized trap doors 52, 54 which are operable to catch the item from the funnel, and to transfer the item to the next station as discussed further herein.

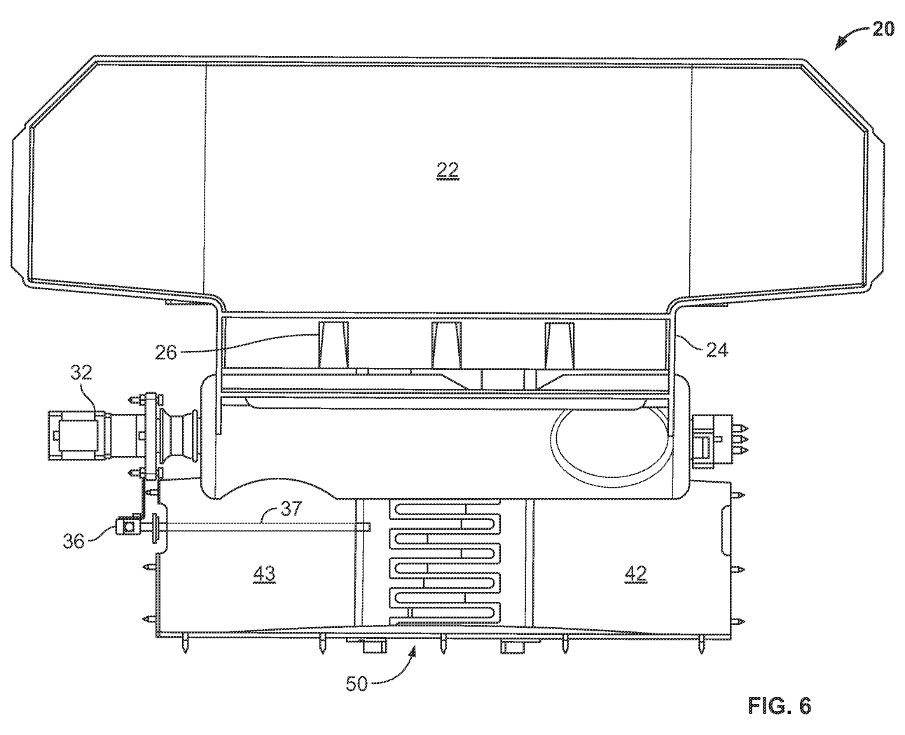

In embodiments, each trap door 52, 54 is shown having elongated fingers extending from a base region. The trap doors cooperate with one another such that the fingers interlace with one another to increase the door length and reduce the distance the item must ultimately free fall. A top view of the interlaced fingers is shown in FIG. 6. The trap door interlacing is shaped so that the item will not rotate while being lowered. In embodiments, the fingers have a slight bow shape, and the interlocking fingers collectively form a bowl or concave shape. An exemplary length of the fingers ranges from 50 to 150 mm. An exemplary width of the fingers ranges from 2 mm to 10 mm. An exemplary radius of curvature of the fingers is 30 mm.

In embodiments, for each left or right trapdoor, the individual fingers may vary in shape. The edge or peripheral fingers may have a tighter curvature (namely, smaller radius) than the middle fingers. The varying shape of the fingers within a hand serves to match a produce having a varying radius. For example, in the case of an avocado, the middle region is larger than the end region. For embodiments, the elongated fingers are arranged and shaped to accommodate the varying size produce by having varying size and curvature fingers within each trapdoor hand.

In use with produce or processing systems where it is not necessary to reduce the produce fall distance or prevent its rotation the trapdoor may use straight fingers or no fingers at all. A single trapdoor may further be used.

The trap doors 52, 54 are preferably removable from the hopper assembly for cleaning. In embodiments, the trap doors removably slide onto a D, double D, splined, square or keyed shaft and are easily removed for cleaning.

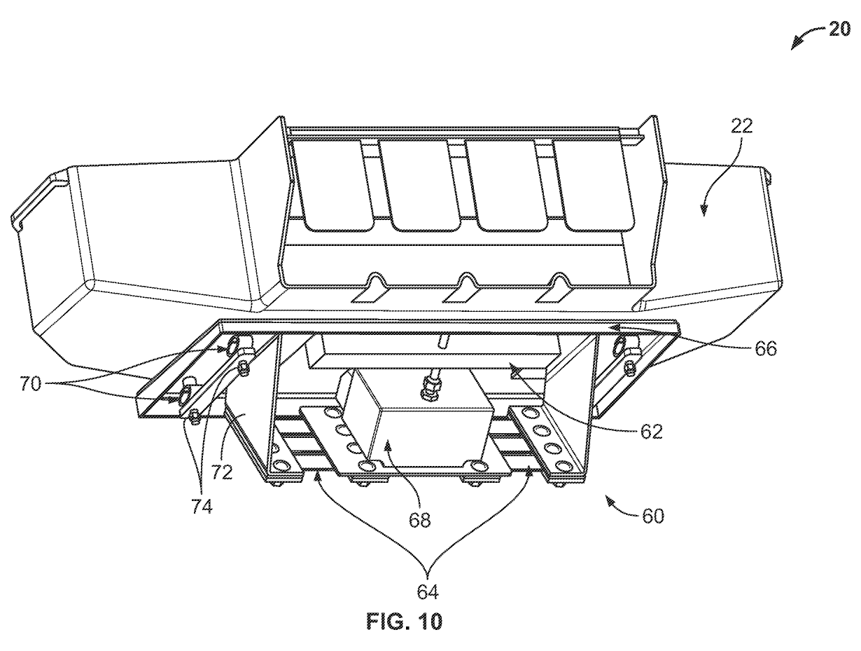

FIG. 10 shows an enlarged view of a vibration assembly 60 for vibrating the hopper bin 22 in accordance with an embodiment of the invention. In embodiments, the vibration assembly 60 is a miniature harmonic vibration driver and consists of a first mass (namely, the hopper bin 22 of objects) and second mass 68 connected by flat springs 64. First mass is shown fastened to a mounting structure 66 via soft springs 70. The soft springs 70 serve to isolate the vibration of the vibration driver 68 from the mounting structure 66.

A counter weight 62 can be provided to balance the loads.

Second mass 68, which contains the vibration exciter, is coupled to the first mass by the flat springs 64.

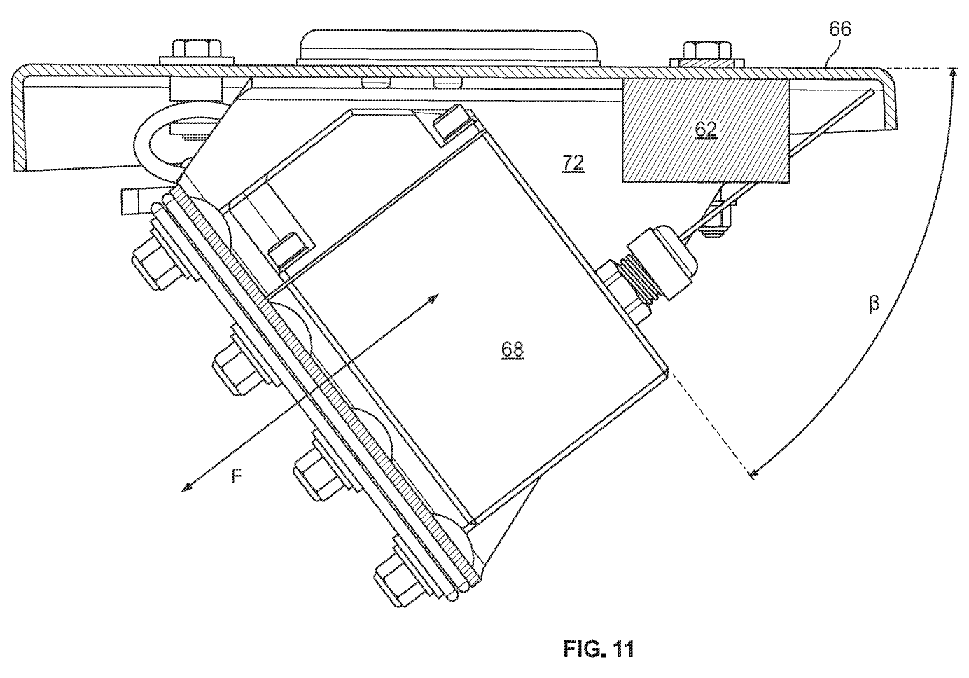

With reference to FIG. 11, the second mass 68 is shown fixed below mounting structure 66 at a throw angle (β) from horizontal. An exemplary range for the throw angle (β) is 15 to 45 degrees. The second mass 68 moves back and forth in the direction (F) when activated.

For embodiments, the vibration exciter itself 68 consists of two counter-rotating eccentric masses powered by one or more electric motors. The rotation speed of these masses is tuned to be just below the natural frequency of the two-mass system, which is targeted to be between 20 and 40 Hz. The flat springs’ 64 length sets the natural frequency and is tuned according to the combined masses of the first and second mass 68.

The driver assembly 60 has a number of advantages. It is operable to convey material (e.g., fruit, produce) along a horizontal or nearly horizontal surface (e.g., the bin floor) while minimizing the energy consumed and the space taken by the driver. It resists the damping of the transported material when fully loaded. It also provides a small footprint and inexpensive manufacturing. It is effective from a full load to a nearly empty load. It also is agnostic to the material being transported; that is, the driver is effective for a wide range of different types of produce or objects.

### METHOD FOR AUTOMATICALLY SINGULATING AN OBJECT

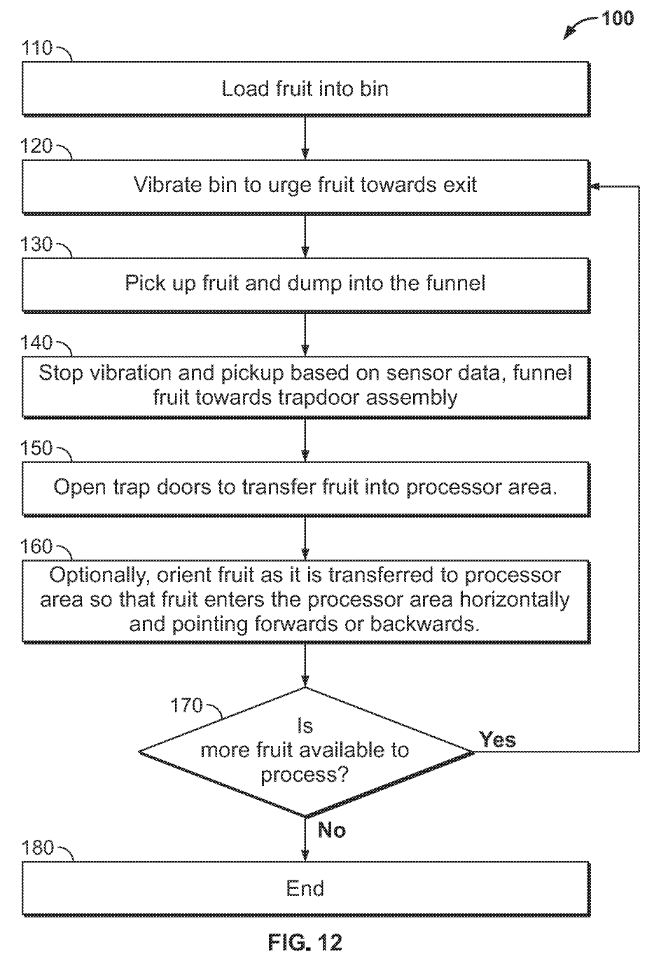

With reference to FIG. 12, an exemplary process 100 for singulating an object from a heap is illustrated. In describing the process 100, reference is also made to FIGS. 5-11. 13-16 for showing various exemplary structures to perform each of the steps of the process.

Step 110 states to load. This step may be carried out by placing one or more objects into the hopper bin 22 shown in FIG. 5. In embodiments, the hopper bin 22 is adapted to store at least a full case worth of avocados, namely, a standard 25 lb. case of avocados of any size or shape from any supplier.

Step 120 states to vibrate bin to urge item towards exit. In preferred embodiments, the hopper assembly 20 is operable to vibrate to facilitate movement of the objects towards the rotating drum 30. A vibrating driver 60, as described above, causes the objects in the bin 22 to move along the floor towards the drum 30.

Optionally, a curtain (26a-26d) is arranged above the interface between the hopper 24 and drum 30 to ensure the objects do not pass over the top of the drum.

Step 130 states to pick up item and dump into the funnel. This step is performed by singulating an object from the batch of objects in the hopper bin 22, 24. The objects are fed along the hopper bin floor towards the rotating drum 30 which includes a plurality of axially-spaced pockets 34. As the drum 30 rotates, an object is picked up by a pocket 34 and dumped downstream into the funnel 40.

Step 140 states to stop vibration and pickup. In embodiments, the feeding is paused when an object enters the funnel 40. In particular embodiments, with reference to FIG. 6, break-beam sensor 36 is arranged to detect when an object is dumped from the pocket 34. When the sensor beam 37 is triggered, the drum 30 and vibration driver 60 are commanded to halt, thereby pausing feeding as the object is translated from the drum 30 to the funnel 40, and to the trapdoor assembly 50.

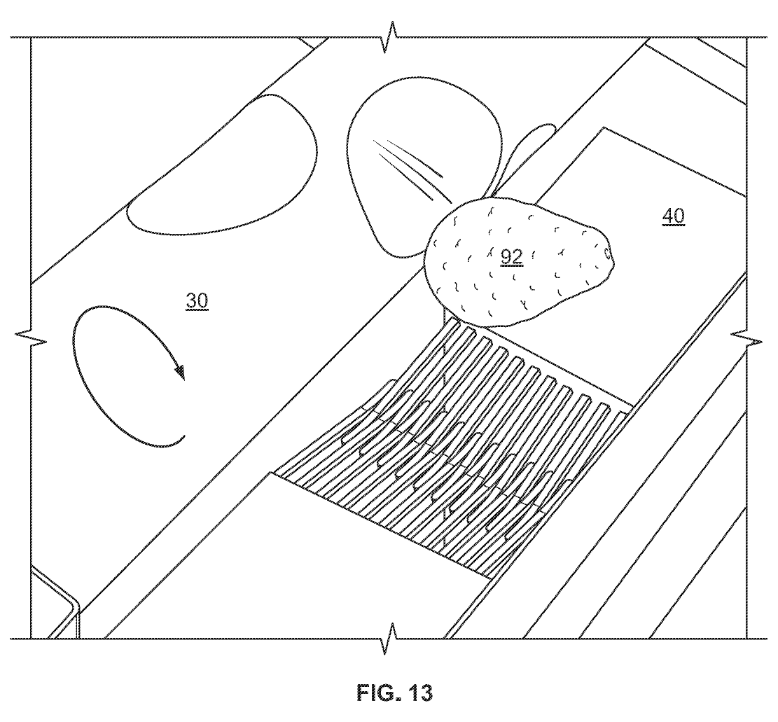

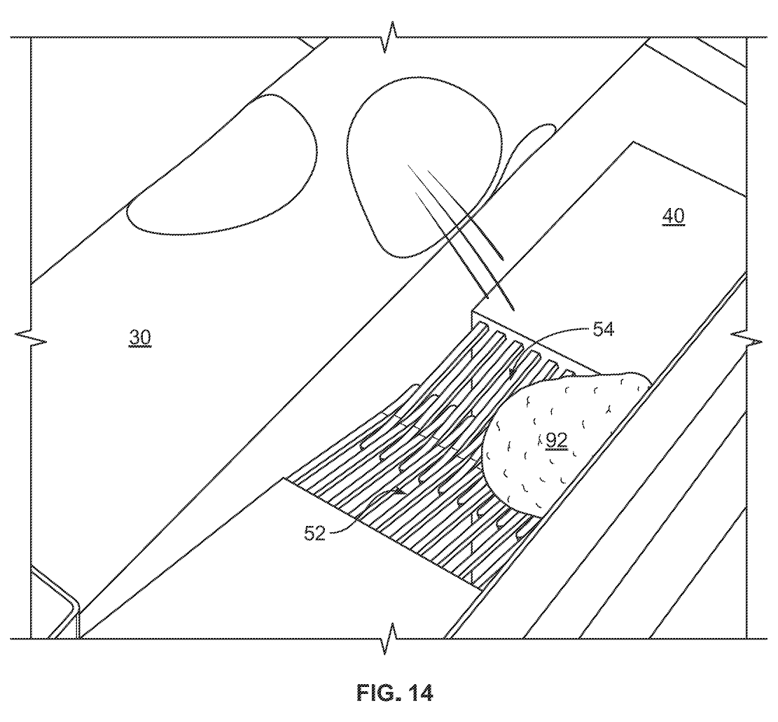

FIGS. 13-14 show sequentially translating an avocado 92 from the drum 30 into the funnel 40, and onto interlaced trapdoors 52, 54, where the trapdoors serve to stage the avocado 92 prior to transfer to the next station.

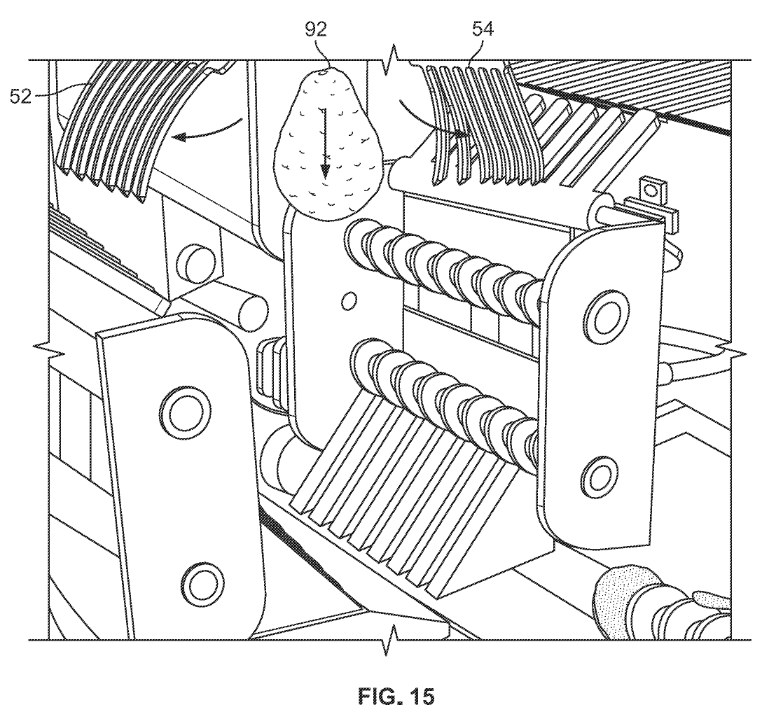

Step 150 states to open trap doors. With reference to FIG. 15, the trapdoors are shown being opened and the item dropping to the next station.

Step 160 states to optionally orient the item as it is transferred to processor area so that item enters the processor area horizontally and pointing forwards or backwards. In embodiments, trap doors bias the orientation of the item to be lowered in a horizontal orientation where by ‘horizontal orientation’, in the context of an object having a major axis (or length), it is meant the major axis (or length) of the object is horizontally oriented.

The elongated fingers of the trap doors 52, 54 interlace with each other to increase the trapdoor’s effective length thereby reducing the ‘drop’ distance that the item must ultimately free fall. The trap door interlacing is shaped with a slight curve and the trapdoors are spaced such that the item will be supported from the bottom so that the item will not rotate while being lowered. The spacing from the ends of the fingers of the trapdoors and the processing area of the next station is minimized and in embodiments, this drop distance ranges from 50 mm to 150 mm.

Step 170 states whether more items are available to process. This step can be performed by determining whether more items are in the hopper bin 22, 24. Software logic for proceeding can include confirming by sensor or a clock data that at least one object remains in the bins. If ‘yes’, the method proceeds to step 120 to feed more objects. If not, the method is ended (step 180), and optionally, an operator is alerted via, e.g., a dashboard or otherwise to check or power off the system.

### COMPUTER AND ELECTRONICS

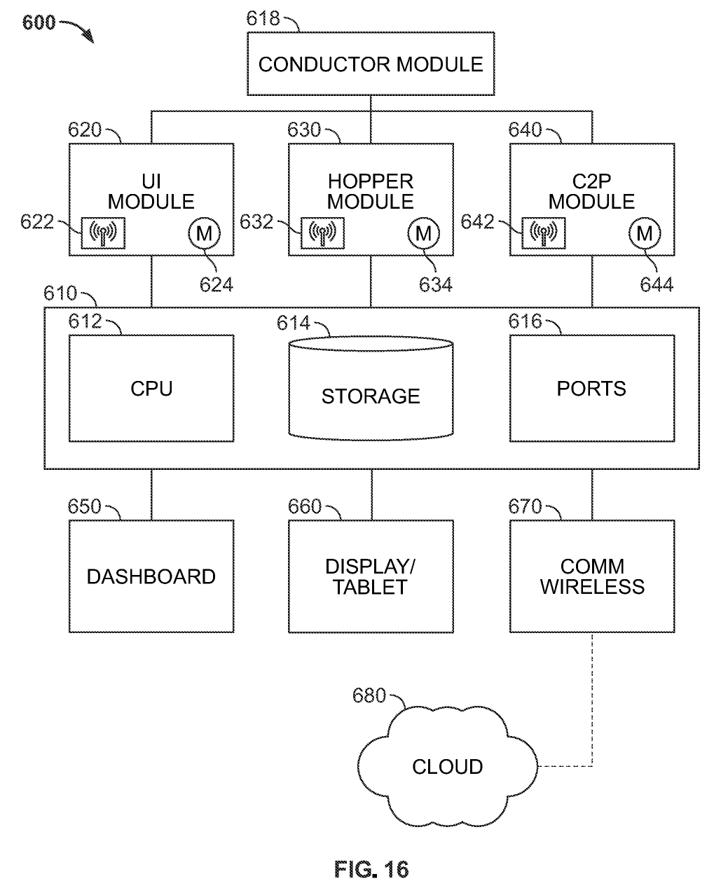

FIG. 16 is a block diagram of an avocado processing system 600 in accordance with embodiments of the invention. The system 600 is shown including a computer 610, conductor module 618, UI module 620, hopper module 630, C2P module 640, and dashboard 650.

Computer 610 is shown including a processor 612, storage 614, and ports 616 (or pins in the case of the micro-controller or PLC) for connecting with various different types of peripherals, devices and/or power. The computer may include one or more processors or a processor framework. The processor is programmed and operable to carry out the steps described herein based on firmware and software (including the various modules) stored in the computer.

In the system 600 shown in FIG. 16, each of UI module 620, hopper module 630, and C2P module 640 can include one or more dedicated sensors 622, 632, 642 and optionally motors 624, 634, and 644. The modules are operable to communicate and share information with the computer 610 including keeping track of the state of the motors, components, and throughput metrics, as described herein.

Power supplies, converters, and other electronic components can be present for carrying out the steps described herein. Some components can be dedicated to one action or module, and other components can be shared. For example, the computer may include a DC power supply to drive each of the motors of the modules. Alternatively, each module may have a dedicated power supply. Indeed, the invention may include a wide range of electronic and mechanical (including pneumatic) configurations.

Optionally, the system 600 may include a display 660 such as monitor or a touchscreen tablet.

Optionally, the system may include a wireless communication board or module 670 for communicating with mobile devices, local networks, and/or remote servers or cloud servers 680.

Although a dashboard was described above including various buttons and switches, embodiments of the invention can include a screen and optionally, a touchscreen, to control the system. A computer may be programmed and operable to show or indicate (e.g., via animation) the status of the dispensing process (e.g., load, dispense, empty, clock, error, etc.). The computer can be programmed and operable to keep statistics of the number objects processed, namely, singulated, or otherwise processed as described herein. Estimates may be based on various operations of the system such as the number of times the first sensor detects an object, the number of times the trapdoors open, etc. In embodiments, a scale may be incorporated into the system to measure the weight of the items in the bin over time. In other embodiments, motions, timing and metrics can be controlled and detected using computer vision. Each of the assemblies may be controlled by standalone electronics or by a main computer or processor programmed and operable to carry out the functions described herein including singulating, orienting, cutting, coring, peeling, and food and waste collection.

Additionally, the system may be programmed and operable for integrated data tracking for metrics including total avocados processed, cycle time, and food safety or expiration. For example, the processor may be programmed to compute the above metrics based on sensor data for time elapsed, mass, volume, and avocado count.

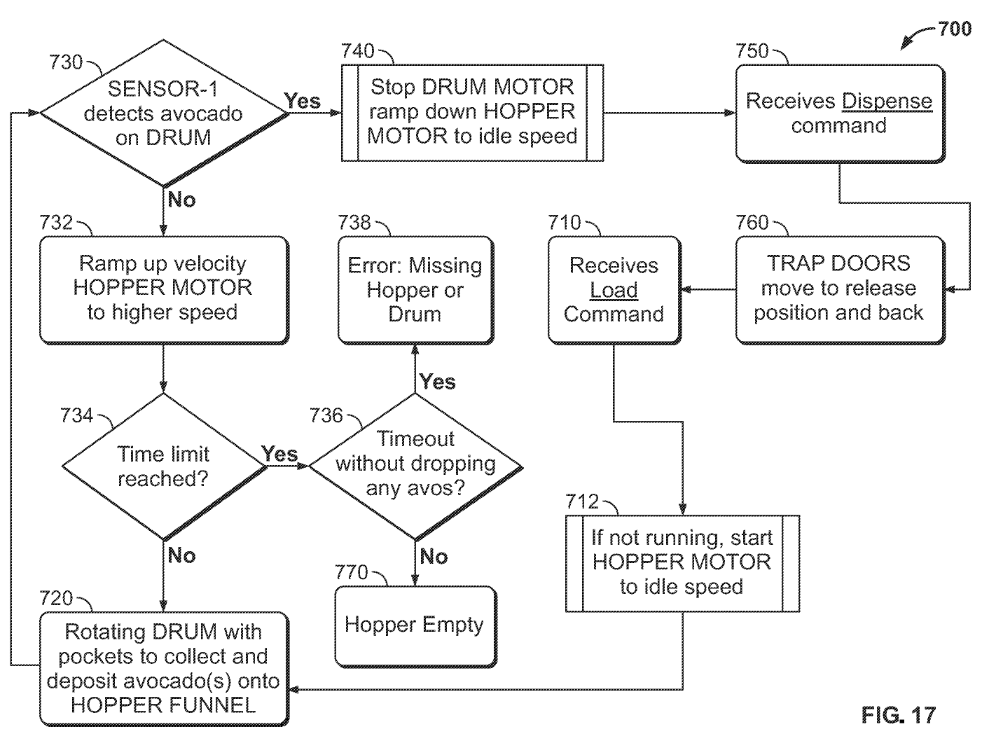

FIG. 17 is a schematic diagram of a hopper module 700 in accordance with an embodiment of the invention.

Step 710 is the start of the process. A load command is received from the conductor module 618 (FIG. 16). In embodiments, the user presses a button to trigger the start of the process.

Next step 712 states if not running, to start hopper motor to idle speed. In embodiments, and with reference to FIG. 10 described above, the vibration exciter 68 is activated at a first or idle speed.

Step 720 states rotating drum with pockets to collect and deposit avocados onto hopper funnel. This step is carried out as described above by activating the motor 32 of the drum 30 to rotate where pockets 34 pickup and transfer the object into the funnel 40.

Step 730 states to detect avocado on drum. This step is performed by sensor 36 detecting for a break in beam 37 by an object falling from the pocket 34 of drum 30.

Step 740 states to stop drum motor and ramp down hopper motor to idle speed if the sensor from step 730 detects an object. This step is carried out to control singulating the object to the funnel.

Step 750 states receive dispense command. This is an instruction to open the trapdoors 50, described above, thereby transferring the object in an aligned orientation to the next processing station below the trapdoors. This instruction is preferably automatically triggered by a downstream sensor. Alternatively, the hopper module can be configured to accept a manual instruction from the user to dispense the object from the trapdoor assembly.

Step 760 states to move to release position and back. Per the instructions from step 750, the doors are opened as indicated above and returned to their closed interlaced configuration for staging the next object, and the method returns to step 710 for load command.

If an avocado is not detected at step 730, the method proceeds to step 732 and the speed of hopper motor is increased. Increasing the speed of the hopper motor tends to move the objects more quickly to the drum, as described above.

Step 734 queries whether the time limit is reached. In embodiments, the hopper module includes logic rules to evaluate whether an object has been detected by the sensor within a threshold amount of time or time limit from the latest Load command (step 710). An exemplary time limit is between 30 seconds and 2 minutes.

If the time limit has not been reached, the method returns to step 720 and steps 720, 730, 732, 734 are sequentially repeated until the sensor detects an object in which case the method proceeds to step 740 or the time limit is reached in which case the method proceeds to step 736.

Step 736 states to query whether an object was dropped. If at least one object was dropped, it is indicative that the hopper is now empty (step 770). If an object was not dropped, it is indicative of an error for missing hopper or drum or other. In embodiments, a UI is configured to notify the user or otherwise display an error message or hopper empty.

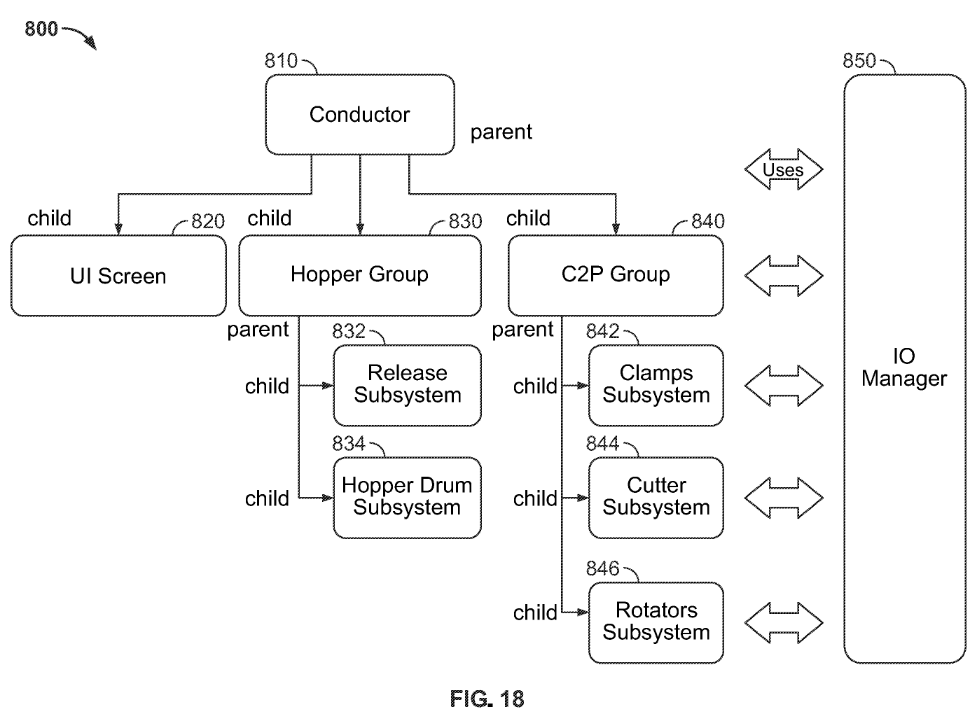

FIG. 18 is a software architecture diagram of an avocado processing system 800 in accordance with an embodiment of the invention. The system 800 shows a conductor module 810 for managing the submodules UI screen 820, hopper group 830, cutting coring and peeling (C2P) group 840 and IO manager 850.

The hopper group 830 is further shown having a hopper drum subsystem 834 and release (namely, trapdoor release) subsystem 832, as described herein to control motors associated with each subsystem.

The C2P group 840 is further shown having a clamp subsystem 842, a cutter subsystem 844, and a rotator subsystem 846 to control motors associated with each subsystem.

The IO manager 850 is operable to, amongst other things, manage data from sensors and motors in order for the subsystems to perform their tasks as described herein.

In embodiments of the invention, a sensor (e.g., break-beam sensor 36) scans for the presence of an avocado entering the funnel, and moving onto the trapdoor. Data from the sensor triggers a mechanism (e.g., electric motor) to halt the vibration driver and the rotating drum.

### ALTERNATIVE EMBODIMENTS

The hardware and electronics may vary.

Examples of types of sensors include, without limitation, proximity sensors, time of flight sensors, ultrasonic sensors, and photoelectric sensors.

Examples of types of actuators include without limitation stepper motors and servomotors.

Optionally, in lieu of sensors, other mechanisms (mechanical-based) can be arranged along the route to singulate the object including, e.g., levers or switches along the route that are triggered when the object passes. The levers and switches may be designed to cause the motors to start and stop. Indeed, a wide range of trigger arrangements to control dispensing and singulation of the object are intended to be included within the scope of the invention.

In embodiments of the invention, the system can include additional sensors and/or vision directed at the various handoff points between stages to qualify and/or quantify attributes of the objects of interest (namely, the produce). For embodiments, for example, qualifying the object can include, but is not limited to detecting whether the object is damaged or bruised; what is the ripeness or visible exterior of the object, and what is the orientation. For embodiments, for example, quantifying the object can include, but is not limited to detecting weight and dimensions. Visions systems can include, e.g., camera(s) and a processor programmed with trained detection and classification models to perform the functions described herein.

In embodiments of the invention, various hardware components of the system are tracked. In one embodiment, an RFID tag is arranged on the component to be tracked. Examples of hardware components to be tracked include, without limitation, consumables such as the drum and trapdoors.

In embodiments of the invention, the system has pre-established quantified datasets for the average mechanical decay rate of each consumable or component to be tracked. As the system operates, the runtime and maturity of the components are tracked using, e.g., a unique ID sensed by the RFID receiver for each component.

In embodiments of the invention, the metrics and data tracking the system records are integrated with end customer Quick Service Restaurants (QSR) inventory and data pipelines. The metrics are uploaded to the QSR databases, providing real time data to help monitor efficiency of operations within the kitchens.

Still other modifications and variations can be made to the disclosed embodiments without departing from the subject invention. For example, the processing system may have more or less functional stations and components than that shown and described herein. The system may also be modified to accommodate a wide range of types objects and produce and preferably, pitted foods such as avocados, plums, peaches, mangoes, papayas, etc.

1. A system for singulating and dispensing an object from a bunch of object comprises:
a hopper adapted to hold the bunch of objects;
a rotating member, optionally a drum, arranged adjacent the hopper and comprising at least one cutout to pick up one object at a time from the bunch of objects in the hopper; and
a funnel arranged on an opposing side of the drum to the hopper, wherein the drum is operable to transfer one of the objects at a time from the hopper to the funnel.

2. The system of claim 1, further comprising a trapdoor assembly at a base of the funnel comprising a first closed configuration for staging the object, and a second open configuration for transferring the object to a processing area for further processing.

3. The system of claim 2, wherein the trapdoor assembly comprises two trapdoors with interlocking elongate fingers that collectively form a concave shape that centers the avocado during the first configuration.

4. The system of claim 3, wherein, upon receiving an open command, the trapdoors open at a variable speed to orient the object before transferring the object.

5. The system of claim 2, wherein the speed at which the trapdoors are opened and, optionally, the motion they follow during opening are managed to control the item drop from the trapdoors.

6. The system of claim 1, further comprising a vibrating assembly arranged with the hopper to urge the bunch of objects towards the drum.

7. The system of claim 6, wherein vibrating assembly comprises a plate mounted to the hopper, and a first mass fixedly mounted to the plate and a second mass spring-mounted to the plate.

8. The system of claim 7, wherein the vibration assembly comprises a vibrator exciter unit, and the second mass is incorporated with the vibrator exciter unit.

9. The system of claim 8, further comprising a first sensor to detect for the object entering the funnel.

10. The system of claim 9, wherein the vibrator exciter unit motion is based on a signal from the first sensor.

11. The system of claim 10, comprising a computer and electronics programmed and operable to continue rotating the drum and increasing the motion of the vibration assembly until (a) a threshold time limit is reached, or (b) an object is translated from the drum to the funnel as detected by the first sensor.

12. The system of claim 1, further comprising a computing device programmed and operable to control the vibration assembly, drum rotation, and opening and closing of the trapdoors, and optionally, wherein the computing device is selected from a computer, PLC and microcontroller.

13. The system of claim 9, wherein the first sensor is break-beam sensor.

14. The system of claim 1, further comprising a curtain arranged above an interface between the hopper and the drum to prevent objects from moving over the drum instead of being picked up one at a time.

15. A method for singulating and dispensing an object from a bunch of objects comprising:
loading the bunch of the objects into a bin;
vibrating the bin to urge the objects towards an exit of the bin;
automatically picking up one of said objects from the exit of the bin;
funneling the object towards a set of trap door forming a staging area;
dispensing the object by opening the trap doors; and
repeating the vibrating, picking, funneling, and dispensing steps until no more objects are detected in the bin.

16. The method of claim 15, further comprising orienting the object by controlling motion and timing of the trap doors during the opening.

17. The method of claim 16, wherein the motion is controlled by opening the trap doors over a first phase and a second phase that follows the first phase, wherein the first phase moves the trap doors more quickly than the second phase.

18. The method of claim 17, wherein the first phase is at least five (2) times faster than the second phase, and optionally, the first phase has a speed ranging from 0.1 rps to 1 rps.

19. The method of claim 15, wherein the object is an avocado, and optionally, wherein the bunch is a full case of avocados.
